(19) United States
(12) Patent Application Publication
(10) Pub. No.: US 2026/0155264 A1
(43) Pub. Date: Jun. 4, 2026

(54) METHOD FOR CONTROLLED THERMONUCLEAR FUSION

(71) Applicant: Aganyan Fusion, Yerevan (AM)

(72) Inventors: Hakop Aganyan, Los Angeles, CA (US); Suren Manukyan, Los Angeles, CA (US); Ashot Gevorkyan, Yerevan (AM); Mary Hrachoohi Boghosian, Yerevan (AM); Leon Kirk Kiraj, Glendale, CA (US); Tsovinar Hambardzumyan, Yerevan (AM); Mikael Aganyan, Los Angeles, CA (US); Mushegian Vaginak, Kiev (UA); Robert Avetisian, Pico Rivera, CA (US); Andranik Avagyan, Yerevan (AM); Gevorg Pilosyan, Yerevan (AM)

(21) Appl. No.: 18/211,305

(22) Filed: Jun. 19, 2023

Related U.S. Application Data
(60) Provisional application No. 63/353,911, filed on Jun. 21, 2022.

(51) Int. Cl. G21B 1/23

(52) U.S. Cl. CPC G21B 1/23

(57) ABSTRACT

Systems and methods for controlled thermonuclear fusion are provided. An example method includes providing a reactor, disposing an anode and a cathode within the reactor, where the anode and the cathode form an interelectrode space, providing, by a capacitor, a positive charge to the anode and a negative charge to the cathode to obtain a predetermined potential difference between the anode and the cathode, charging, by a high-voltage power source, the capacitor to a predetermined capacitance, and introducing a predetermined amount of a liquid including a light element and an electrolyte into the interelectrode space to cause, by the predetermined potential difference, an electric discharge through the liquid, thereby inducing a thermonuclear reaction involving the light element.

### CROSS-REFERENCE TO RELATED APPLICATIONS

The present application claims priority of U.S. Provisional Patent Application No. 63/353,911 filed on Jun. 21, 2022, entitled “METHOD FOR CONTROLLED THERMONUCLEAR FUSION.” The subject matter of aforementioned application is incorporated herein by reference in its entirety for all purposes.

### TECHNICAL FIELD

The present invention relates to controlled thermonuclear fusion and, more specifically, to thermonuclear fusion using accelerated gaseous plasma masses.

### BACKGROUND

Recently, much attention has been paid to the problem of developing a thermonuclear reactor. Such a reactor could provide a solution to the world's energy problems, since one of the main fusion fuels is deuterium or an isotope of hydrogen (tritium). In addition, the fusion reactor is inherently stable and does not explode.

The upside of fusion reactions is that it is almost impossible to cause an uncontrolled reaction or meltdown, unlike conventional nuclear power plants. In addition, the main waste product of the hydrogen synthesis is an inert gas. This process may cause some reactor materials to become radioactive. However, the radioactivity of the material is low and the amount of “hazardous” waste is practically non-existent compared to the conventional nuclear power plants.

Thermonuclear fusion involves the convergence, “unification,” of light nuclei to form a heavier nucleus, which, due to a mass defect, occurs with the release of energy in accordance with the Einstein's theory E=mc². The fusion takes place at extremely high temperatures, which is approximately 15,000,000° C. For example, the deuterium-tritium fusion reaction occurs at temperatures above 175,000,000° C., while the deuterium-deuterium fusion reaction occurs at about 232,000,000° C.

At these extremely high temperatures and pressures, the gas will ionize and form plasma, that is, a collection of a huge number of electrons and positive ions (≥10²⁰/m³) that constantly interact with each other, exchanging energy.

However, to carry out the fusion of one proton, it is necessary to accelerate a great number of protons, because the probability of fusion of a proton with a light nucleus is extremely small. Although the energy released during the fusion of a proton is large, this energy is much less than the total energy used to accelerate protons that have merged and also all the protons that have not merged.

One of the difficulties of the fusion reaction is that atomic nuclei are positively charged and repel each other. To overcome this repulsion, the atoms need to be moved very quickly in a limited space, which makes a collision more likely.

There are two principal schemes for the implementation of controlled thermonuclear fusion based on the light isotopes of deuterium ²H and tritium ³H, namely:

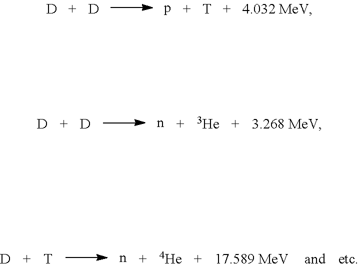

The principal schemes of the implementation of the controlled thermonuclear fusion are the following:

A. Quasi-stationary reactors, in which plasma is heated and confined by a magnetic field at relatively low pressure and high temperature. Such reactors include Tokamak, Stellarator (Torsatron), and a mirror trap, which differ in the configuration of the magnetic field. The most promising among quasi-stationary reactors is the International Thermonuclear Experimental Reactor (ITER) that has the Tokamak configuration.

B. Pulse reactors. In such systems, controlled thermonuclear fusion is carried out by short-term heating of small targets containing deuterium and tritium using super-powerful laser beams or beams of high-energy particles (ions, electrons). Such irradiation causes a sequence of thermonuclear micro explosions.

The second type of reactors (B) has been very little studied due to various types of technical difficulties, for example, due to the lack of super-powerful lasers in the field of X-ray and gamma radiation, and so on. As for the first type of reactors (A), the most important role for these devices is played by the magnetic field, which serves as a trap for the plasma and keeps the plasma from coming into contact with other components of the reactor.

For the implementation of thermonuclear fusion, the following conditions must be met:
1. The cathode and the anode are made of a metal enriched, under high pressure, with light elements.
2. The speed of collision of nuclei is high enough and on the temperature scale of more than T>10⁸ K (for D-T reactions).
3. Fulfill the Lawson criterion τn≥10¹⁴ cm⁻³ sec, where n is the density of high-temperature plasma, and τ is the plasma retention time in the trap.

The value of τn depends on the type of fuel and on the plasma temperature. According to calculations for all known types of fuel, the deuterium-tritium mixture provides the smallest values of τn, at least an order of magnitude, and the lowest reaction temperature, at least by 5 times than other types of fuel.

In Tokamaks, the most difficult task is to isolate the plasma from the walls of the device. As practice shows, in various installations, plasma can at best be kept for several tens of seconds due to the inevitable development of instability in a magnetized plasma.

Another unsolvable difficulty is the impossibility of isolating the intense neutron flux emanating from the plasma confinement volume. The neutron flux creates the induced radioactivity of the parts of the installation, and also becomes the cause of their radiation corrosion. The problem is aggravated by the fact that the interaction cross section of neutrons with nuclei ceases to depend on the number of nucleons with increasing energy and tends to the cross section of the atomic nucleus, and for 14 MeV neutrons there is no isotope with a sufficiently small interaction cross section.

An important problem for radioactive safety is the prevention of the spread of the radioactive isotope of tritium, which requires very complex and special ventilation installations to maintain a reduced pressure in the reactor building. It is also very problematic to create stable and strong magnetic fields-traps to keep the plasma at the temperature of about 10⁸ K for a long time, which would increase the coefficient of the “useful” energy from the thermonuclear fusion reaction, i.e., the ratio of spent and received energy. At the moment this ratio is 1:1.25, which is not very impressive. In addition, it is still unclear how profitable the production of electricity using thermonuclear fusion can be. Another negative side of the deuterium-tritium fusion reaction is the artificial origin of the tritium isotope, which requires additional complex technological solutions.

Thus, it can be concluded that despite the large number (about 300) of Tokamak experimental facilities, there are many unsolved technical and technological problems that leave little hope for the implementation of controlled nuclear fusion with the cost-effective extraction of any significant amount of positive energy.

Existing devices used to support a nuclear fusion reaction use temperatures much higher than the temperature of the surface of the Sun, which creates enormous technical difficulties for their continuous and safe operation. For example, the Tokamak fusion facility in Princeton, New Jersey, operates by magnetic confinement in a huge 250-ton supercooled electromagnet. The electromagnet generates and controls a strong magnetic field, physically supporting the fusion reaction. However, the Tokamak facility never operates for more than a few tens of seconds due to instabilities arising from the movement of a magnetized plasma in a magnetic field, which seems to be a fundamental and yet unsurmountable difficulty for these devices.

Thus, currently, thermonuclear fusion can be considered as the only promising and acceptable (in many important parameters) energy of the future for our civilization, which, unfortunately, has not yet been implemented in the form of a real energy producing device.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

According to one example embodiment of the present disclosure, a system for controlled thermonuclear fusion is provided. The system may include a reactor and an anode and a cathode disposed in the reactor. The anode and the cathode may form an interelectrode space. The system may further include a capacitor configured to provide a positive charge to the anode and a negative charge to the cathode to obtain a predetermined potential difference between the anode and the cathode. The system may further include a high-voltage power source configured to charge the capacitor to a predetermined capacitance. Upon introduction of a predetermined amount of a liquid including a light element and an electrolyte into the interelectrode space, the predetermined potential difference causes an electric discharge through the liquid, thereby inducing a thermonuclear reaction involving the light element.

According to another embodiment of the present disclosure, a method for controlled thermonuclear fusion is provided. The method may include providing a reactor and disposing an anode and a cathode within the reactor. The anode and the cathode may form an interelectrode space. The method may further include providing, by a capacitor, a positive charge to the anode and a negative charge to the cathode to obtain a predetermined potential difference between the anode and the cathode. The method may continue with charging, by a high-voltage power source, the capacitor to a predetermined capacitance. The method may further include introducing a predetermined amount of a liquid including a light element and an electrolyte into the interelectrode space to cause, by the predetermined potential difference, an electric discharge through the liquid, thereby inducing a thermonuclear reaction involving the light element.

Other example embodiments of the disclosure and aspects will become apparent from the following description taken in conjunction with the following drawings.

### BRIEF DESCRIPTION OF THE DRAWINGS

Exemplary embodiments are illustrated by way of example and not limitation in the figures of the accompanying drawings, in which like references indicate similar elements.

FIG. 1 illustrates a system for controlled thermonuclear fusion, according to an example embodiment.

FIG. 2 illustrates a system for controlled thermonuclear fusion, according to another example embodiment.

FIG. 3 illustrates a method for controlled thermonuclear fusion, according to an example embodiment.

### DETAILED DESCRIPTION

The following detailed description of embodiments includes references to the accompanying drawings, which form a part of the detailed description. Approaches described in this section are not prior art to the claims and are not admitted to be prior art by inclusion in this section. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and operational changes can be made without departing from the scope of what is claimed. The following detailed description is, therefore, not to be taken in a limiting sense, and the scope is defined by the appended claims and their equivalents.

The embodiments of this disclosure relate to systems and methods for controlled thermonuclear fusion of light elements, for example, deuterium, tritium, lithium, and others. There are various thermonuclear reactions involving light nuclei that occur without the participation of neutrons. “Neutron-less” reactions are very promising, since, unlike thermonuclear reactions that generate a neutron flux, they do not create induced radioactivity harmful to the environment. To obtain energy, the most promising “neutron-less” thermonuclear reactions are the following:

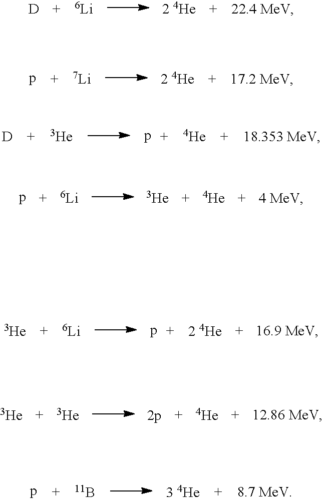

Almost a hundred years ago, when the structure of the nucleus became known, scientists suggested that high-energy processes occurring during a thunderstorm could initiate nuclear reactions. Recent studies by various authors have shown that this assumption is close to reality.

In particular, as shown by numerous measurements (see, for example, T. Enoto, et al. Photonuclear reactions triggered by lightning discharge. Nature, volume 551, pages 481-484 (2017)), lightning really initiates various kinds of nuclear chain reactions in the atmosphere, such as generation of new isotopes.

The afterglow phenomena that occur after a lightning strike, as proven experimentally (see, for example, T. Torii, M. Takeishi, and T. Hosono. Observation of gamma-ray dose increase associated with winter thunderstorm and lightning activity. J. Geophys. Res. 107, 4324 (2002)), initiates various kinds of chain reactions in the atmosphere. Namely, the emerging gamma-flash is powerful enough and knocks out neutrons from nitrogen atoms in the air. After this, neutrons are re-captured by nitrogen atoms, but with the emission of radiation in the visible light range. Isotopes of nitrogen atoms ¹³N, which failed to re-capture neutrons, undergo a chain radioactive decay and transfer to stable carbon atoms ¹²C with the emission of various types of charged and neutral elementary particles. The inventors observed all these phenomena in the experiment carried out by the inventors. However, this raises a reasonable question, namely: how can nuclear reactions occur in a plasma with the temperature of T˜4×10⁴ K, while according to all the laws of modern physics this should not have happened? For example, in the deuterium-tritium fusion reaction, the energy required to overcome the Coulomb barrier is 0.1 MeV. The conversion between energy and temperature shows that the 0.1 MeV barrier will be overcome at above 1.2×10⁹ K.

The systems and the methods of present disclosure provide obtaining a thermonuclear reaction using a powerful electric discharge via an electro-hydraulic shock in a medium containing light elements, for example, deuterium, tritium, lithium, and others.

Despite the relatively low temperature of the plasma, an electro-hydraulic shock causes an instant detachment of electrons (mainly hydrogen atoms), which move with acceleration to the anode. This acceleration is so significant that the electron bunch produces intense radiation in the hard x-ray and gamma ranges. In particular, if a gamma photon has an energy of the order of 1 MeV, the energy of the electron emitting this photon should most likely be several times greater than the photon energy and, accordingly, the actual temperature of the electron bunch in this case will be ˜10¹⁰ K. It is this radiation that leads to the phenomena of atmospheric afterglow, after which nuclear chain reactions occur. The instantaneous collective detachment of electrons leads to a “Coulomb explosion” of the remaining “bare” core protons, i.e., hydrogen atoms in all directions, which causes the temperature of the nucleon component of the plasma of T˜4×10⁴ K. One liter of hydrogen plasma with an electron temperature of 1×10⁸ K and an electron density of 1×10¹⁶ cm⁻³ emits X-rays with a power of about 150 kW.

The electro-hydraulic shock also creates a condition for accelerating the proton bunch along the anode-cathode direction, and as a result of acceleration the proton bunch acquires a kinetic energy, on average, much higher than the energy due to the plasma temperature. It was the translational energy acquired as a result of acceleration that made it possible to assume that positively charged particles, in particular protons, which already have sufficient energy, such as not lower than 0.1 MeV, can overcome the Coulomb barrier of nuclei with a tangible probability due to quantum tunneling, thereby carrying out thermonuclear fusion.

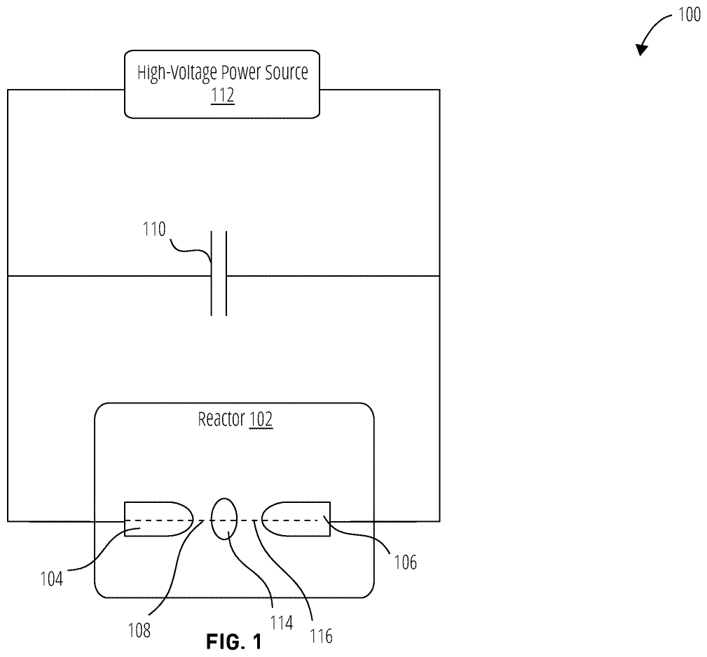

FIG. 1 shows a system 100 for controlled thermonuclear fusion, according to example embodiment. The system 100 is a two-electrode system. The system 100 may include a reactor 102 and two electrodes shown as an anode 104 and a cathode 106 disposed in the reactor 102. The anode 104 and the cathode 106 may form an interelectrode space 108. The system 100 may further include a capacitor 110 configured to provide a positive charge to the anode 104 and a negative charge to the cathode 106 to obtain a predetermined potential difference between the anode 104 and the cathode 106.

The system 100 may further include a high-voltage power source 112. The high-voltage power source 112 may be configured to charge the capacitor 110 to a predetermined capacitance. The anode 104 and the cathode 106 may be connected to the terminals of the capacitor 110. The charge deferential between the anode 104 and the cathode 106 may be approximately equal to the applied high voltage. After charging the capacitor 110 completely (i.e., when the charging current of the capacitor 110 is minimum and close to zero), a predetermined amount of a liquid (shown as a drop of liquid 114) may be introduced into the interelectrode space 108. The liquid may include a light element and an electrolyte. In particular, the drop of liquid 114 may be enriched with hydrogen. The liquid may include a drop of heavy water D₂O with the addition of sodium hydroxide NaOH (the electrolyte) to increase the electrical conductivity of the liquid. Solid metal electrodes may be used as the anode 104 and the cathode 106, and in some embodiments the cathode 106 may be enriched with a lithium isotope.

Upon introduction of the predetermined amount of the liquid into the interelectrode space 108, the predetermined potential difference causes an electric discharge through the liquid, thereby inducing a thermonuclear reaction involving the light element.

In an example embodiment, the cathode 106 may include tungsten. In another example embodiment, the cathode 106 may be enriched with an isotope of lithium. In some example embodiments, the liquid may include lithium.

To increase the probability of a thermonuclear reaction, the anode electrode and the cathode electrode can also be made of a conductive metal (for example, palladium and others) enriched under high pressure with molecules of light elements, such as hydrogen, deuterium, tritium and others.

The admixture of light elements in a palladium metal lattice increases the lattice parameter (the length between two points on the corners of a unit cell of the lattice), thereby creating the internal tension. This leads to the effect of finding the molecules of the light element under high pressure depending on the concentration. Under pressure, nuclei of light elements are able to interact with the liquid introduced into the interelectrode space 108 with a high probability.

After occurring of the electric discharge (electro-hydraulic shock) between the electrodes through a drop of liquid 114, the medium explodes, turning into a plasma, which propagates in the form of a shock wave mainly along the anode-cathode first line 116. This process is accompanied by powerful radiation predominantly in the short-wave frequency range.

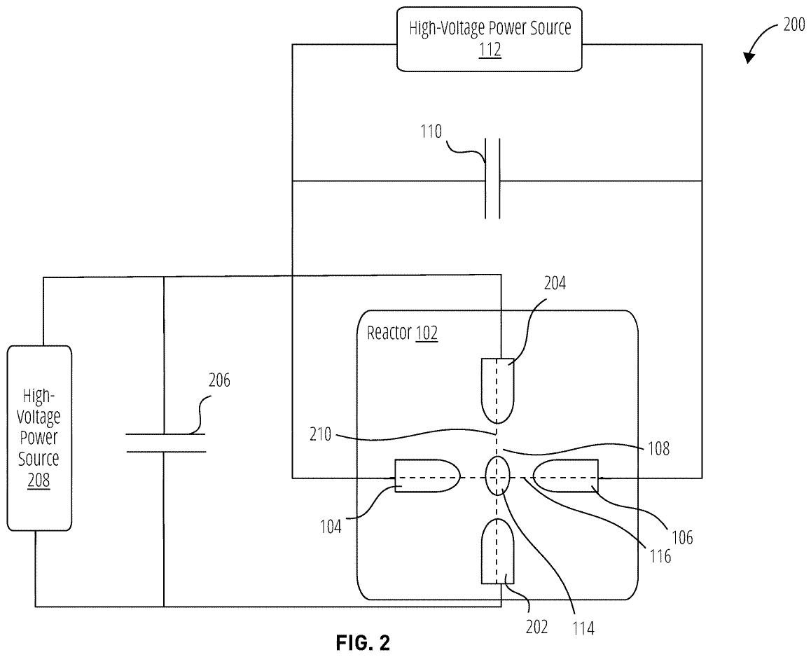

FIG. 2 shows a system 200 for controlled thermonuclear fusion, according to example embodiment. The system 200 is a four-electrode system. The system 200 may include a reactor 102 and electrodes shown as an anode 104 and a cathode 106 disposed in the reactor 102. The anode 104 and the cathode 106 may form an interelectrode space 108. The system 200 may further include a capacitor 110 configured to provide a positive charge to the anode 104 and a negative charge to the cathode 106 to obtain a predetermined potential difference between the anode 104 and the cathode 106. The system 200 may further include a high-voltage power source 112. The high-voltage power source 112 may be configured to charge the capacitor 110 to a predetermined capacitance. The anode 104 and the cathode 106 may be connected to the terminals of the capacitor 110.

The system 200 may further include two more electrodes shown as a further anode 202 and a further cathode 204 disposed in the reactor 102. The further anode 202 and the further cathode 204 may form the interelectrode space 108 along with the anode 104 and the cathode 106.

The anode 104 and the cathode 106 may be disposed along a first line 116. The further anode 202 and the further cathode 204 may be disposed along a second line 210. The second line 210 may be orthogonal to the first line 116.

The number of sets of electrodes and geometrical configuration of electrodes within reactor 102 can be different. In some example embodiments, the geometrical configuration of the anode 104 and the cathode 106 and the further anode 202 and the further cathode 204 can be different from that shown in FIG. 2, i.e., the second line 210 may not be orthogonal to the first line 116.

The system 200 may further include a further capacitor 206. The further anode 202 and the further cathode 204 may be connected to the terminals of the further capacitor 206. The further capacitor 206 may be configured to provide a further positive charge to the further anode 202 and a further negative charge to the further cathode 204 to obtain the predetermined potential difference between the further anode 202 and the further cathode 204. The system 200 may further include a further high-voltage power source 208 configured to charge the further capacitor 206 to a further predetermined capacitance.

After charging the further cathode 204, a predetermined amount of a liquid (shown as a drop of liquid 114) enriched with hydrogen may be introduced into the interelectrode space 108. The liquid may include a light element and an electrolyte. For example, the liquid may include a drop of heavy water D₂O with the addition of sodium hydroxide NaOH (electrolyte) to increase electrical conductivity of the liquid. In an example embodiment, the further cathode 204 may be enriched with the lithium isotope.

After occurring of an electric discharge (electro-hydraulic shock) between the electrodes through a drop of liquid 114, the medium explodes, turning into a plasma, which propagates in the form of a shock wave mainly along the anode-cathode first line 116 and anode-cathode second line 210. This process is accompanied by powerful radiation predominantly in the short-wave frequency range.

Based on the embodiment shown in FIG. 1, pilot studies have been carried out by the inventors. Two tungsten electrodes with an area of 0.5 cm² and a thickness of 0.3 cm² each were used. The cathode 106 was enriched with lithium isotope, approximately 3% of the total number of atoms per unit volume of the electrode. The liquid included heavy water D₂O and sodium hydroxide and a weight of the sodium hydroxide was 3% of a weight of the heavy water. Specifically, the environment subjected to electro-hydraulic shock consisted of heavy water D₂O, approximately 0.25 g, with the addition of 3% sodium hydroxide NaOH (0.0075 g) to increase the electrical conductivity of the medium.

Experiments carried out by the inventors have shown that after an electro-hydraulic shock, the medium explodes and turns into a plasma. The phenomenon is accompanied by intense gamma and beta radiation. The measuring instruments showed that the process (after a bright glow is observed) is accompanied by powerful radiation in the short-wave frequency range, which is very important since that range indicates the occurrence of the nuclear fusion process D+⁶Li→2 ⁴He+22.4 MeV. The boundaries of the short-wave frequency range may depend on the chosen capacitance value and high voltage value. Repeated experiments showed the same emission spectrum, characterized by a peak near the frequency of ν≈3.4×10¹² Hz, which unambiguously confirms the occurrence of the indicated thermonuclear fusion.

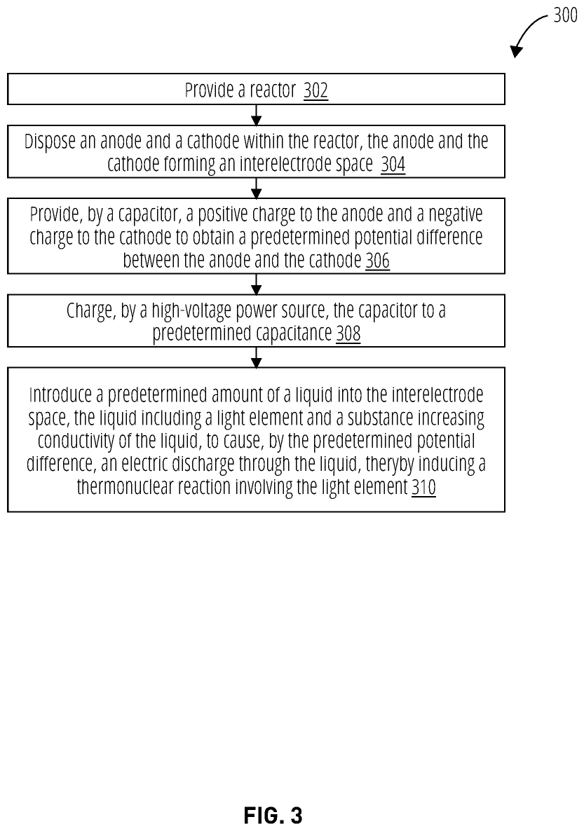

FIG. 3 is a flow chart of a method 300 for controlled thermonuclear fusion, according to an example embodiment. In some embodiments, the operations may be combined, performed in parallel, or performed in a different order. The method 300 may also include additional or fewer operations than those illustrated.

The method 300 may commence in block 302 with providing a reactor. In block 304, the method 300 may continue with disposing an anode and a cathode within the reactor. The anode and the cathode may form an interelectrode space. In an example embodiment, the cathode may include tungsten. The cathode may be enriched with an isotope of lithium.

In block 306, the method 300 may include providing, by a capacitor, a positive charge to the anode and a negative charge to the cathode to obtain a predetermined potential difference between the anode and the cathode. In block 308, the method 300 may continue with charging, by a high-voltage power source, the capacitor to a predetermined capacitance. In block 310, the method 300 may include introducing a predetermined amount of a liquid into the interelectrode space. The liquid may include a light element and a substance increasing conductivity of the liquid. The substance increasing the conductivity may include an electrolyte. In particular, the liquid may include heavy water D₂O. The liquid may include any substance that causes improvements in conductivity and does not interfere with the nuclear fusion. An example electrolyte may include sodium hydroxide, sodium bicarbonate, acetic acid, sodium chloride, or other salts. In an example embodiment, the liquid may include heavy water D₂O and sodium hydroxide and a weight of the sodium hydroxide may be 3% of a weight of the heavy water. In an example embodiment, the liquid may include lithium.

The introducing of the predetermined amount of the liquid into the interelectrode space may cause, by the predetermined potential difference, an electric discharge through the liquid, thereby inducing a thermonuclear reaction involving the light element.

In an example embodiment, prior to the introducing of the predetermined amount of the liquid into the interelectrode space, the method 300 may include disposing a further anode and a further cathode in the reactor. The anode and the cathode may be disposed along a first line, and the further anode and the further cathode may be disposed along a second line, where the second line and the first line may form a predetermined angle. The predetermined angle can be 90 degrees.

The further anode and the further cathode may form the interelectrode space along with the anode and the cathode. The method 300 may further include providing, by a further capacitor, a further positive charge to the further anode and a further negative charge to the further cathode to obtain the predetermined potential difference between the further anode and the further cathode. The method 300 may further include charging, by a further high-voltage power source, the further capacitor to a further predetermined capacitance.

If compared to the concept of thermonuclear fusion in Tokamak, the method 300 for controlled thermonuclear fusion using electro-hydraulic shock is significantly cheaper and its technical implementation is obviously incomparably simpler and more reliable, both in terms of scaling and control. Unlike Tokamak, in the system of the present disclosure, there is no need to have a very expensive and complex magnetic trap to contain high-temperature plasma. There is also practically no problem associated with organizing protection against intense neutron fluxes. In addition, to initiate thermonuclear fusion, the cost of the necessary initial energy is negligible, and the elements for the implementation of thermonuclear fusion, especially for nuclear reactions D+⁶Li→2 ⁴He+22.4 MeV and p+⁷Li→2 ⁴He+17.2 MeV, are very accessible and cheap on our planet.

The safety and reliability of the method 300 for controlled thermonuclear fusion is associated primarily with a simple and fully controlled mechanism for the implementation of electro-hydraulic shock in a conductive medium, which serves as a trigger for the process of thermonuclear fusion.

Thus, the method 300 for controlled thermonuclear fusion based on light isotopes of deuterium, lithium, and tritium, in order to provide controlled thermonuclear fusion and simplify the fusion process, uses the following parameters:
1. A powerful pulsed electrical discharge (electro-hydraulic shock) is used, which occurs through a drop of liquid enriched with hydrogen—for example, a drop of heavy water;
2. The discharge occurs at the moment when the drop of liquid enters the interelectrode space;
3. The number of electrodes can be two, four, or more;
4. In order to increase electrical conductivity, sodium hydroxide or any other material that may increase the conductivity is added to the drop of liquid; and
5. In order to provide tritium during nuclear fusion, the cathodes of the electrodes are enriched with lithium isotopes and the neutron produced by nuclear fusion reacts with lithium to form tritium.

Thus, systems and methods for controlled thermonuclear fusion have been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A system for controlled thermonuclear fusion, the system comprising:
a reactor;
an anode and a cathode disposed in the reactor, the anode and the cathode forming an interelectrode space;
a capacitor configured to provide a positive charge to the anode and a negative charge to the cathode to obtain a predetermined potential difference between the anode and the cathode; and
a high-voltage power source configured to charge the capacitor to a predetermined capacitance, wherein upon introduction, into the interelectrode space, of a predetermined amount of a liquid, the liquid including a light element and a substance increasing conductivity of the liquid, the predetermined potential difference causes an electric discharge through the liquid, thereby inducing a thermonuclear reaction involving the light element.

2. The system of claim 1, wherein the substance includes an electrolyte.

3. The system of claim 1, wherein the liquid includes heavy water D₂O.

4. The system of claim 1, wherein the liquid includes heavy water D₂O and an electrolyte.

5. The system of claim 1, wherein the cathode includes tungsten.

6. The system of claim 1, wherein the cathode is enriched with an isotope of lithium.

7. The system of claim 6, wherein the liquid includes lithium.

8. The system of claim 1, further comprising:
a further anode and a further cathode disposed in the reactor, the further anode and the further cathode forming the interelectrode space along with the anode and the cathode;
a further capacitor configured to provide a further positive charge to the further anode and a further negative charge to the further cathode to obtain the predetermined potential difference between the further anode and the further cathode; and
a further high-voltage power source configured to charge the further capacitor to a further predetermined capacitance.

9. The system of claim 8, wherein:
the anode and the cathode are disposed along a first line; and
the further anode and the further cathode are disposed along a second line, the second line and the first line forming a predetermined angle.

10. The system of claim 9, wherein the predetermined angle is 90 degrees.

11. A method for controlled thermonuclear fusion, the method comprising:
providing a reactor;
disposing an anode and a cathode within the reactor, the anode and the cathode forming an interelectrode space;
providing, by a capacitor, a positive charge to the anode and a negative charge to the cathode to obtain a predetermined potential difference between the anode and the cathode;
charging, by a high-voltage power source, the capacitor to a predetermined capacitance; and
introducing a predetermined amount of a liquid into the interelectrode space, the liquid including a light element and a substance increasing conductivity of the liquid, to cause, by the predetermined potential difference, an electric discharge through the liquid, thereby inducing a thermonuclear reaction involving the light element.

12. The method of claim 11, wherein the substance includes an electrolyte.

13. The method of claim 11, wherein the liquid includes heavy water D₂O.

14. The method of claim 11, wherein the liquid includes heavy water D₂O and an electrolyte.

15. The method of claim 11, wherein the cathode includes tungsten.

16. The method of claim 11, wherein the cathode is enriched with an isotope of lithium.

17. The method of claim 16, wherein the liquid includes lithium.

18. The method of claim 11, further comprising, prior to the introducing the predetermined amount of the liquid into the interelectrode space:
disposing a further anode and a further cathode in the reactor, the further anode and the further cathode forming the interelectrode space along with the anode and the cathode;
providing, by a further capacitor, a further positive charge to the further anode and a further negative charge to the further cathode to obtain the predetermined potential difference between the further anode and the further cathode; and
charging, by a further high-voltage power source, the further capacitor to a further predetermined capacitance.

19. The method of claim 18, wherein:
the anode and the cathode are disposed along a first line; and
the further anode and the further cathode are disposed along a second line, the second line and the first line forming a predetermined angle.

20. The method of claim 19, wherein the predetermined angle is 90 degrees.
